(19) United States
(12) Patent Application Publication
(10) Pub. No.: US 2014/0176449 A1
(43) Pub. Date: Jun. 26, 2014

(54) Methods and Apparatus For Electronic Device Control

(71) Applicant: NOKIA CORPORATION, Espoo (FI)

(72) Inventor: Antti Kangaskoski, Yloja rvi (FI)

(73) Assignee: Nokia Corporation, Espoo (FI)

(21) Appl. No.: 13/724,347

(22) Filed: Dec. 21, 2012

(51) Int. Cl. G06F 3/041

(52) U.S. Cl. CPC G06F 3/041
USPC 345/173

(57) ABSTRACT

Systems and techniques for controlling an electronic device are described. An electronic device comprises one or more touch sensitive areas, including side touch sensitive areas. Configuration information is stored for operational modes of the electronic device, with the operation of the touch sensitive areas being defined as part of the configuration information. For example, configuration information may define the size, location, responsiveness, and operation of regions operating as controls—that is, regions with which contact causes the device to perform defined operations. The configuration may also include user preference information, which may further define the operation of touch sensitive regions in particular operational modes of the device. Regions of sensitive areas, particularly side touch sensitive areas, may be illuminated to indicate the position and size of controls, and illumination patterns indicating locations and sizes of controls may be stored as part of the configuration information.

### TECHNICAL FIELD

The present invention relates generally to electronic device control. More particularly, the invention relates to customizable control locations for an electronic device.

### BACKGROUND

As the variety, capability, and demands made on electronic devices continue to increase, the desire of users to adapt their devices to their own individual needs also increases. Many modern devices can be used in different ways—for example, as a telephone, as an electronic book reader, as an instant messaging device, as a still or video camera, as a sound recorder, as a video and sound player, for as a wireless networking access point. Different users may wish to use their devices primarily in particular operational modes, to perform particular operations or combinations of operations. One user may wish to use his or her device more frequently as a music or video player, one user may wish to use his or her device more frequently as a camera, and another user may wish to use his or her device more often as an electronic reader. Different controls may be better adapted and more convenient for different operational modes, and different users may wish to configure their own controls.

### SUMMARY

In one embodiment of the invention, an apparatus comprises at least one processor and memory configured to store computer program code. The memory configured to store the computer program code is configured to, with the at least one processor, cause the apparatus to at least store configuration information defining a plurality of operational modes of an electronic device. The configuration information comprises control information defining a configuration of at least one touch sensitive area of the device. The configuration of the touch sensitive area comprises at least one of location and size, and the configuration information also defines response to contact of at least one region of the touch sensitive area of the device. Response to contact comprises performing at least one operation upon detection of a contact, and the configuration of the touch sensitive area is based on an operational mode with which the configuration information is associated. In response to selection of an operational mode of the electronic device, the configuration information defining the operational mode of the device is retrieved and the apparatus causes the electronic device to respond to contacts with the touch sensitive area to perform operations. The response of the electronic device is based at least in part on the configuration information.

In another embodiment of the invention, a method comprises storing configuration information defining a plurality of operational modes of an electronic device. The configuration information comprises control information defining a configuration of at least one touch sensitive area of the device. The configuration of the touch sensitive area comprises at least one of location and size, and the configuration information also defines response to contact of at least one region of the touch sensitive area of the device. Response to contact comprises performing at least one operation upon detection of a contact, and the configuration of the touch sensitive area is based on an operational mode with which the configuration information is associated. In response to selection of an operational mode of the electronic device, the method further comprises retrieving the configuration information defining the operational mode of the device and causing the electronic device to respond to contacts with the touch sensitive area to perform operations. The response of the electronic device is based at least in part on the configuration information.

In another embodiment of the invention, a computer readable medium stores a program of instructions, execution of which by a processor configures an apparatus to at least store configuration information defining a plurality of operational modes of an electronic device. The configuration information comprises control information defining a configuration of at least one touch sensitive area of the device. The configuration of the touch sensitive area comprises at least one of location and size, and the configuration information also defines response to contact of at least one region of the touch sensitive area of the device. Response to contact comprises performing at least one operation upon detection of a contact, and the configuration of the touch sensitive area is based on an operational mode with which the configuration information is associated. In response to selection of an operational mode of the electronic device, the configuration information defining the operational mode of the device is retrieved and the apparatus causes the electronic device to respond to contacts with the touch sensitive area to perform operations. The response of the electronic device is based at least in part on the configuration information.

### BRIEF DESCRIPTION OF THE DRAWINGS

FIG. 1 illustrates a device according to an embodiment of the present invention;

FIGS. 2, 3A, 3B, 4A, and 4B illustrate control configurations according to embodiments of the present invention; and

FIG. 5 illustrates a process according to an embodiment of the present invention.

### DETAILED DESCRIPTION

One or more embodiments of the present invention recognize that many devices have hard wired controls, particularly side controls. Front controls frequently use touch sensitive areas so that a user may touch areas of a touch sensitive area, but side controls often primarily include physical components and associated wiring to internal components of a device, are disposed in fixed locations on a device and are difficult to change. Embodiments of the invention further recognize that touch sensitive devices provide considerable versatility to control of devices and that placing touch sensitive components on the sides of devices provides flexibility to the placement and use of side controls. Embodiments of the invention also recognize that flexibility in placement and programming is particularly advantageous in the case of side controls. Side controls are more attractive to users if they are configured or configurable to a user's desired use. A user would frequently like to activate or execute an operation using a side control without a need to look at the control or concentrate on using the control, but instead simply recognize the location of the control through familiarity with the size and feel of the device. Users may wish for side controls to be adapted both to the particular mode in which a device is operating, and to their particular preferences. For example, a left-handed user may wish for controls to be in one configuration and a right-handed user may wish for controls to be in an opposite configuration. In addition, some users may wish to configure their device so that specific controls are not configured at all, for example, if a user does not ever use the camera function they may configure the controls so that a camera activation control never appears on the device.

Embodiments of the present invention therefore provide for a device using a touch sensitive area on one or more sides of the device, such as the left, right, top, and bottom sides as they appear when a device display screen is facing a user, portions of a front or rear face of a device, or any other desired areas of a device. Device operations may be activated when contact with a region of a touch sensitive area is detected, with regions being defined based on a particular operation being selected, user preferences, or both. The touch sensitive areas may be of variable size depending on user preferences, and may be illuminated by activating light emitting diodes underneath the touch sensitive areas, so that a user will recognize which regions are used to select operational modes. A user may configure an operational mode and the device will define side keys for the operational mode by recognizing touch sensitive regions as selecting, performing, or initiating appropriate operations. In addition, a user may, at initial device configuration, while configuring an operational mode, or at other times, define specific adaptations of controls to a user's preference. Suitably, the controls will have a default configuration unless otherwise defined by the user.

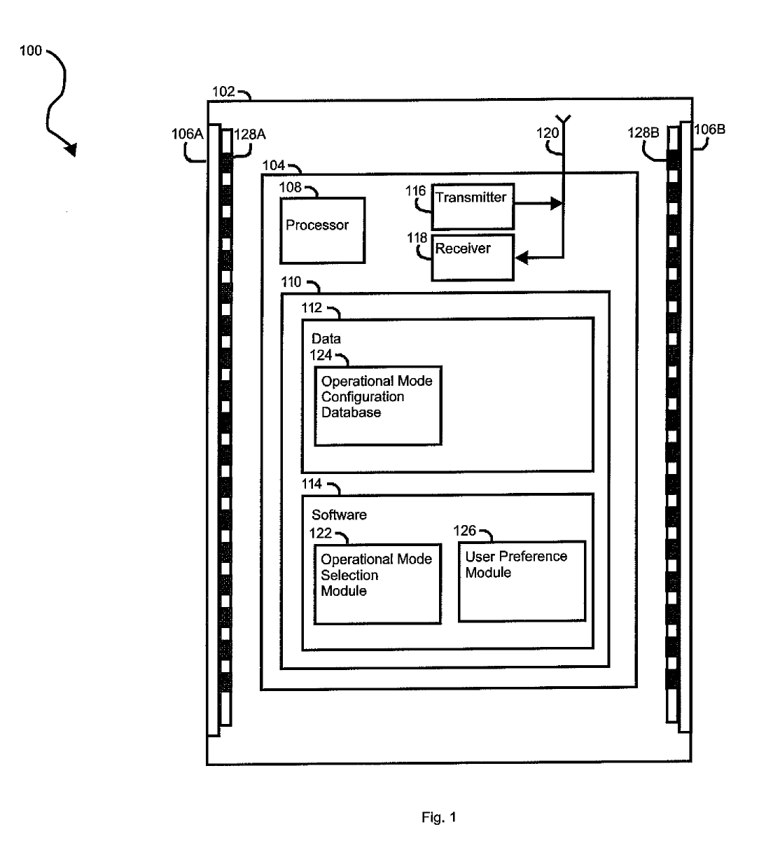

FIG. 1 illustrates a device 100 according to an embodiment of the invention. The device 100 comprises a housing 102, front touch sensitive surface 104, and side touch sensitive surfaces 106A and 106B. It will be recognized that the configuration illustrated here is exemplary, and that touch sensitive surfaces may be implemented where desired, such as at top and bottom edges, or a rear face, of a device. It will further be recognized that devices need not be rectangular, and may be configured in complex shapes, such as circular, oval, or of multiple components such as slide or flip devices. Touch surfaces may therefore be configured as wraparound surfaces, or distributed across multiple portions of a device.

The device 100 also includes a processor 108, memory 110, as well as data 112 and software 114 residing in the memory 110. The device 100 may also include a transmitter 116, receiver 118, and antenna 120. The device 100 may be configurable to operate in a number of modes and perform a number of operations, with an operational mode or operation being selected, for example, based on user inputs to the front touch sensitive surface 104. User inputs to the front touch sensitive surface are generally made using a more attentive and focused approach, with a user noting the identity of an icon to be touched or manipulated and deliberately selecting the icon and the manipulation of the icon based on the result to be achieved. When certain operational modes are selected, side controls for those operational modes may also be available through activation of the side touch sensitive surfaces 106A and 106B.

One or both of the side touch sensitive surfaces 106A and 10613 may be configured so as to implement controls dedicated to a particular operational mode that has been selected. This can be easily accomplished through recognition by the processor 108, controlled by software 114, that a particular operational mode has been selected. The software 114 may, for example, comprise an operational mode selection module 122 that presents a set of icons to a user. When a user selects an operational mode, such as through contact with an associated icon (by, for example, direct touch or approach to a near proximity to the front touch sensitive surface 104), the selection module 122 may select one of a plurality of operational mode configurations that may, for example, be stored in an operational mode configuration database 124. An operational mode configuration may define a control configuration for a particular operational mode—that is, may define the regions of the front touch sensitive area 104 and the side touch sensitive areas 106A and 106B for which contacts are to be recognized as implementing a particular operation, and may define how particular contacts and movements are to be interpreted. For example, a sliding action may be recognized as a volume control and an application of gentle pressure followed by increased pressure may be recognized as focusing a camera and then capturing an image. Different responses and combinations of responses to contacts may be defined in associated with different operational modes, and the definitions associated with each operational mode may be stored as part of an operational mode configuration in the database 124.

In addition, the device 100 may implement a user preference module 126, which may be implemented as part of the software 114. The user preference module 126 may allow for user adjustment of controls, particularly of side controls. For example, a user may wish a volume control to be larger or smaller than a default volume control, or a left-handed user may wish for particular controls to be placed on the side touch sensitive surface 106B, while a default configuration places them on the surface 106A. The user preference module 126 may present a selection screen as a display on the front touch sensitive surface 104, allowing a user to select placement of side controls and drag the controls to size them. The user selections may be stored as part of each operational mode configuration in the database 124.

The device 100 may suitably comprise one or more illuminators, of which light emitting diode (LED) arrays 128A and 128B are an example, placed beneath the side touch sensitive surfaces 106A and 106B. Selected ones of the LEDs of the arrays 128A and 128B may be illuminated when a side control is active, showing the placement and size of the side control.

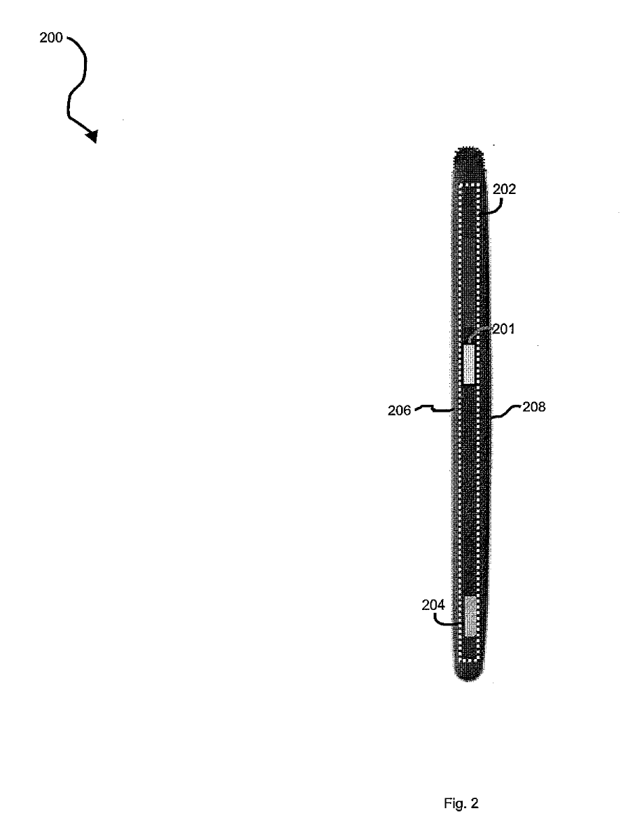

FIG. 2 illustrates an external view of a device 200 according to an embodiment of the invention. The device 200 includes a mechanical power button 201 and a side touch sensitive area 202. In the example presented here, the device 200 is configured as a camera, so that a camera shutter control button 204 has been defined. The camera shutter control button 204 is defined by illuminating a region comprising the shutter control button 204 and controlling the device 200 so that specified actions by the user, such as an application of pressure to the region defining the shutter control button 204, will cause the device 200 to capture an image. The device 200 has suitably been configured so that selection of the camera mode illuminates the region comprising the button 204 and configuring the actions to be taken upon recognition of a contact with the button 204. The front face 206 and rear 208 of the device 200 are not clearly visible in this view, but it can be seen from their identification by the reference numerals that the button 204 appears on the left side of the device 200.

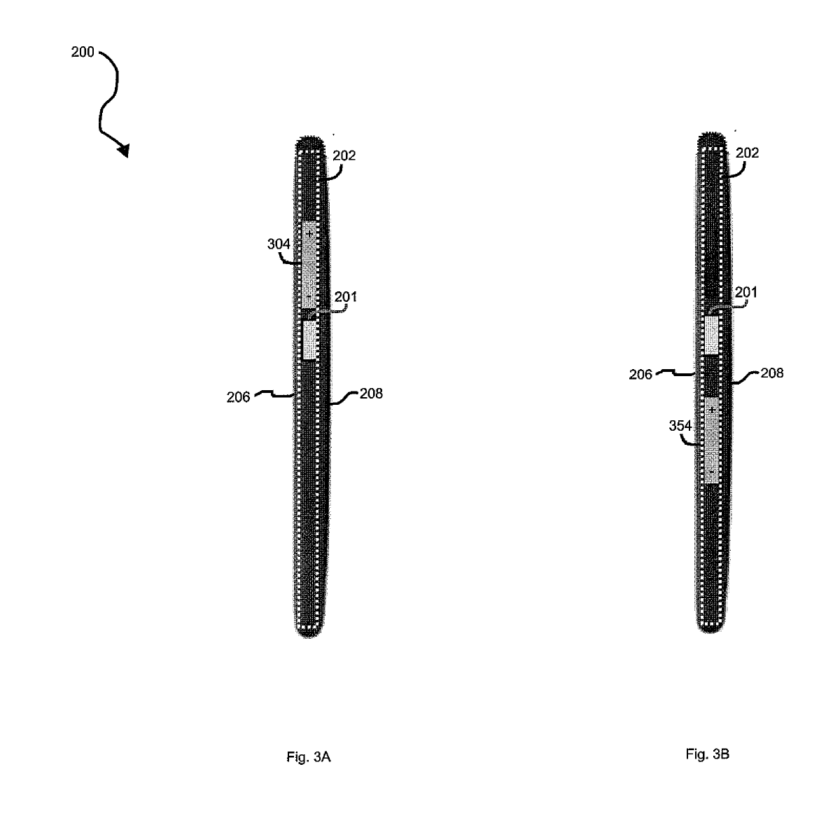

FIGS. 3A and 3B illustrate the device 200 in different configurations. FIGS. 3A and 3B show the device 200 configured to operate in a different mode than that illustrated in FIG. 2. The operational mode may, for example, be that of a voice telephone and the control illustrated here is a volume control that may be used as an in-call control. FIG. 3A illustrates the device 200, mechanical power button 201, and side touch sensitive area 202, as well as front face 206 and rear 208 of the device. A volume control 304 is defined as a region of the touch sensitive area 202, with touches to an upper portion of the volume control 304 being recognized as an indication to increase volume and touches to a lower portion of the volume control 304 being recognized as an indication to decrease volume.

FIG. 3B again illustrates the device 200, mechanical power button 201, and side touch sensitive area 202, as well as the front face 206 and rear 208 of the device. In this case, a volume control 354 is defined, operating in the same way as the volume control 304 of FIG. 3A. However, in the example illustrated in FIG. 3B, the volume control 354 is placed lower in the touch sensitive area 202 than is the volume control 304 of FIG. 3A. This lower placement can be accomplished through configuration of user preferences, suitably using a user preference module such as the user preference module 126 of FIG. 1.

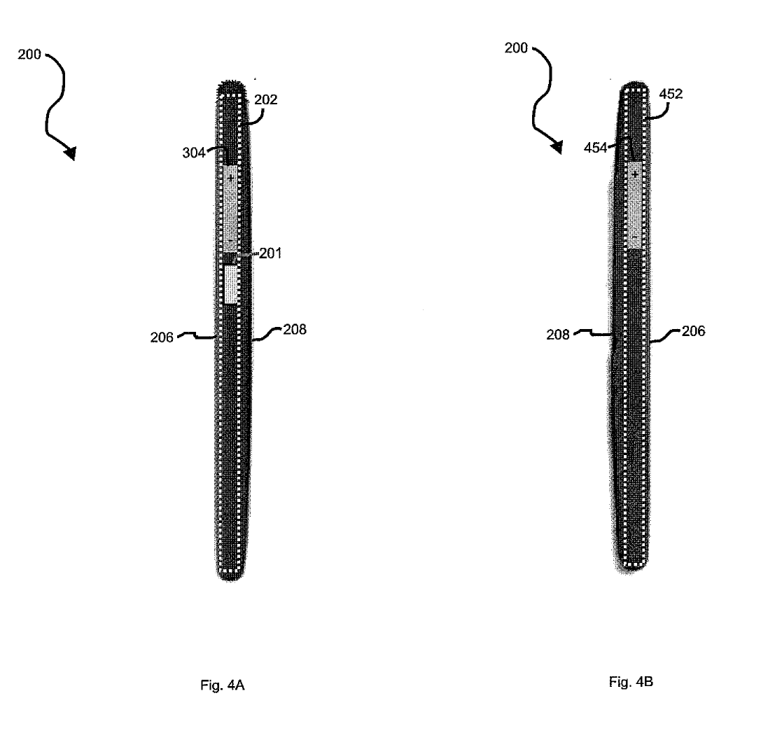

In addition to configuring touch sensitive regions to behave differently when a device is in different operational modes, or to place controls in different regions, one or more embodiments of the invention provide convenient mechanisms for placing controls on one side or the other of a device—for example, to adapt the device for more convenient right-handed or left-handed use. FIGS. 4A and 4B illustrate the device 200 with a volume control in different configurations, so that FIG. 4A shows the device 200 with a volume control on the left side of the device, and FIG. 4B shows the device 200 with a volume control on the right side of the device. FIG. 4A shows the device 200 configured as in FIG. 3A, with the mechanical power switch 201 and, and touch sensitive region 202 being visible, and the front face 206 and rear 208 being indicated, with the volume control 304 configured in the same way as the volume control 304 of FIG. 3A. However, 4B shows the device 200 in an opposite orientation from that of FIGS. 3A and 4A. In the orientation shown in FIG. 4B, the mechanical power switch 201 and the touch sensitive area 202 are not visible, and the front face 206 and rear 208 are on opposite sides from those shown by FIG. 4A. A touch sensitive area 452 appears on the left side of the device, and a volume control 454 is configured as a region of the touch sensitive area 452. In one or more embodiments of the invention, a user may be given an opportunity for a user to select left-handed operation or right-handed operation, and one or the other of the side touch sensitive areas 202 or 452 may be configured for the control areas.

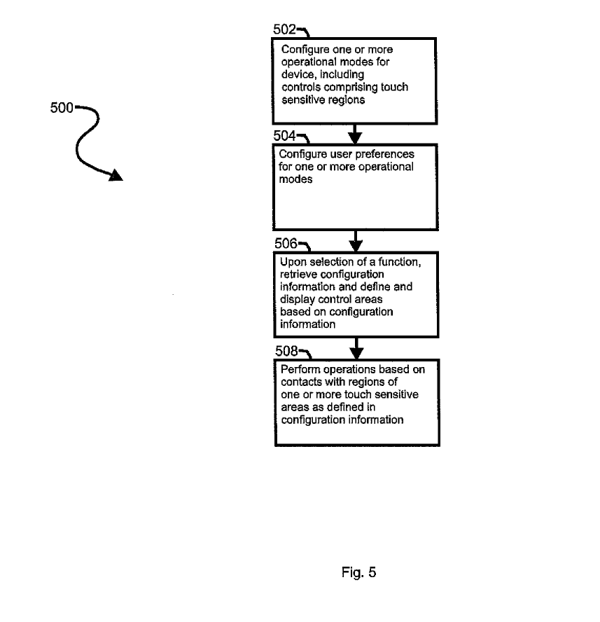

FIG. 5 illustrates a process 500 according to an embodiment of the present invention. At block 502, one or more operational modes are configured for a device, with the configuration of the one or more operational modes comprising configuration of touch sensitive regions in particular locations, particularly on the sides of the device, to respond in particular ways to contacts in order to carry out operations associated with the operational modes. At block 504, user preferences are configured for one or more of the operational modes, defining characteristics such as placement, size, and responsiveness of touch sensitive regions associated with operations relating to operational modes. At block 506, upon selection of an operational mode, configuration information relating to the operational mode is retrieved and control regions are defined based in the configuration information, with control regions made visible to the user through illumination or other appropriate mechanisms. At block 508, operations are performed based on contacts with regions of one or more touch sensitive areas as defined in the configuration information for the operational mode. The blocks 502-508 may represent, for example, steps of a method, code sections of a computer program, or the like. It will be recognized that the specific blocks presented here are exemplary, and that the operations presented here may be reordered, or one or more of the operations may be omitted, depending on design choice.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

We claim:

1. An apparatus comprising:
at least one processor;
memory configured to store computer program code;
wherein the memory configured to store the computer program code is configured to, with the at least one processor, cause the apparatus to at least:
store configuration information defining a plurality of operational modes of an electronic device; wherein the configuration information comprises control information defining a configuration of at least one touch sensitive area of the device, wherein the configuration of the touch sensitive area comprises at least one of location and size, and wherein the configuration information also defines response to contact of at least one region of the touch sensitive area of the device, wherein response to contact comprises performing at least one operation upon detection of a contact, and wherein the configuration of the touch sensitive area is based on an operational mode with which the configuration information is associated;
in response to selection of an operational mode of the electronic device, retrieve the configuration information defining the selected operational mode of the device; and
cause the electronic device to respond to contacts with the touch sensitive area to perform operations, wherein the response of the electronic device is based at least in part on the configuration information.

2. The apparatus of claim 1, wherein at least one touch sensitive area is a side touch sensitive area.

3. The apparatus of claim 2, wherein the electronic device comprises at least one illuminator configured to illuminate at least one region of the side touch sensitive area, and wherein the control information comprises information defining an illumination pattern of the side touch sensitive area, wherein the illumination pattern defines illumination of at least one touch sensitive area configured as a control.

4. The apparatus of claim 1, wherein the control information further comprises user preference information defining at least one of size, location, and response to contact of at least one region of the touch sensitive area of the device based on at least one user selection.

5. The apparatus of claim 4, wherein the electronic device comprises two side touch sensitive areas on opposite sides of the device and wherein the user preference information comprises a selection of one of left-handed and right-handed operation, and wherein at least one control is configured to be located on one of the side touch areas based on the selection of one of left-handed and right-handed operation.

6. The apparatus of claim 4, wherein the user preference information specifies a location of a touch sensitive region configured as a control.

7. The apparatus of claim 4, wherein the user preference information specifies a size of a touch sensitive region configured as a control.

8. A method comprising:
storing configuration information defining a plurality of operational modes of an electronic device; wherein the configuration information comprises control information defining a configuration of at least one touch sensitive area of the device, wherein the configuration of the touch sensitive area comprises at least one of location and size, and wherein the configuration information also defines response to contact of at least one region of the touch sensitive area of the device, wherein response to contact comprises performing at least one operation upon detection of a contact, and wherein the configuration of the touch sensitive area is based on an operational mode with which the configuration information is associated;
in response to selection of an operational mode of the electronic device, retrieving the configuration information defining the operational mode of the device; and
causing the electronic device to respond to contacts with the touch sensitive area to perform operations, wherein the response of the electronic device is based at least in part on the configuration information.

9. The method of claim 8, wherein at least one touch sensitive area is a side touch sensitive area.

10. The method of claim 9, wherein the electronic device comprises at least one illuminator configured to illuminate at least one region of the side touch sensitive area, and wherein the control information comprises information defining an illumination pattern of the side touch sensitive area, wherein the illumination pattern defines illumination of at least one touch sensitive area configured as a control.

11. The method of claim 8, wherein the control information further comprises user preference information defining at least one of size, location, and response to contact of at least one region of the touch sensitive area of the device based on at least one user selection.

12. The method of claim 11, wherein the electronic device comprises two side touch sensitive areas on opposite sides of the device and wherein the user preference information comprises a selection of one of left-handed and right-handed operation, and wherein at least one control is configured to be located on one of the side touch areas based on the selection of one of left-handed and right-handed operation.

13. The method of claim 11, wherein the user preference information specifies a location of a touch sensitive region configured as a control.

14. The method of claim 11, wherein the user preference information specifies a size of a touch sensitive region configured as a control.

15. A computer readable medium storing a program of instructions, execution of which by a processor configures an apparatus to at least:
store configuration information defining a plurality of operational modes of an electronic device; wherein the configuration information comprises control information defining a configuration of at least one touch sensitive area of the device, wherein the configuration of the touch sensitive area comprises at least one of location and size, and wherein the configuration information also defines response to contact of at least one region of the touch sensitive area of the device, wherein response to contact comprises performing at least one operation upon detection of a contact, and wherein the configuration of the touch sensitive area is based on an operational mode with which the configuration information is associated;
in response to selection of an operational mode of the electronic device, retrieve the configuration information defining the selected operational mode of the device; and
cause the electronic device to respond to contacts with the touch sensitive area to perform operations, wherein the response of the electronic device is based at least in part on the configuration information.

16. The computer readable medium of claim 15, wherein at least one touch sensitive area is a side touch sensitive area.

17. The computer readable medium of claim 16, wherein the electronic device comprises at least one illuminator configured to illuminate at least one region of the side touch sensitive area, and wherein the control information comprises information defining an illumination pattern of the side touch sensitive area, wherein the illumination pattern defines illumination of at least one touch sensitive area configured as a control.

18. The computer readable medium of claim 15, wherein the control information further comprises user preference information defining at least one of size, location, and response to contact of at least one region of the touch sensitive area of the device based on at least one user selection.

19. The computer readable medium of claim 18, wherein the electronic device comprises two side touch sensitive areas on opposite sides of the device and wherein the user preference information comprises a selection of one of left-handed and right-handed operation, and wherein at least one control is configured to be located on one of the side touch areas based on the selection of one of left-handed and right-handed operation.

20. The computer readable medium of claim 18, wherein the user preference information specifies a location of a touch sensitive region configured as a control.
